(19) United States
(12) Patent Application Publication
(10) Pub. No.: US 2025/0078362 A1
(43) Pub. Date: Mar. 6, 2025

(54) LOCAL IMAGE AND SCENE EDITING BY TEXT INSTRUCTIONS

(71) Applicant: SAMSUNG ELECTRONICS CO., LTD., Suwon-si (KR)

(72) Inventors: Ashkan MIRZAEI, Toronto (CA); Tristan Ty Aumentado-Armstrong, Toronto (CA); Marcus A. Brubaker, Toronto (CA); Igor Gilitschenski, Toronto (CA); Aleksai Levinshtein, Thornhill (CA); Konstantinos G. Derpanis, Toronto (CA)

(73) Assignee: SAMSUNG ELECTRONICS CO., LTD., Suwon-si (KR)

(21) Appl. No.: 18/816,534

(22) Filed: Aug. 27, 2024

Related U.S. Application Data
(60) Provisional application No. 63/536,671, filed on Sep. 5, 2023.

(51) Int. Cl. G06T 11/60; G06F 40/40; G06T 5/60; G06T 5/70

(52) U.S. Cl. CPC G06T 11/60; G06F 40/40; G06T 5/60; G06T 5/70

(57) ABSTRACT

A method for editing a local area of a target image using a diffusion model, includes: receiving an input image; receiving a text instruction to edit the input image; generating a relevance map based on the diffusion model and the text instruction; generating a rendered image by performing a relevance guided image editing method on the input image, based on the generated relevance map; and providing, to the user, the generated rendered image.

### CROSS-REFERENCE TO RELATED APPLICATION(S)

This application is based on and claims priority under 35 U.S.C. § 119 to U.S. Provisional Patent Application No. 63/536,671, filed on Sep. 5, 2023, in the U.S. Patent & Trademark Office, the disclosure of which is incorporated by reference herein in its entirety.

### BACKGROUND

### 1. Field

The disclosure relates to a method of editing a two dimensional (2D) image and a method of a three dimensional (3D) scene with a text instruction, and an apparatus for the same.

More particularly, the disclosure relates to a method for localizing a desired edit region implicit in the text instruction by using a denoising diffusion model (such as InstructPix2Pix (IP2P)) and identifying a discrepancy, which is represented by a ‘relevance map.’ The relevance map identifies a discrepancy between a first prediction of an object (the 2D image or the 3D scene) with the text instruction and a second prediction of the object without the text instruction. The disclosure also relates to an apparatus for the same.

### 2. Description of Related Art

The crucial role of images in various aspects of modern societies, including social media, marketing, and education, naturally introduces a desire for automated generative approaches for image editing. Neural radiance field (in short, NeRF) (models/methods/operations) is increasingly accessible and popular as an intuitive visualization modality, thus editing NeRF is also receiving significant attention. The remarkable success of denoising diffusion models in generating high-quality images from texts has led to diffusion models being adopted for image editing. Recently, ‘InstructNeRF2NeRF’ (IN2N) (models/methods/operations) demonstrated how to use ‘InstructPix2Pix’ (IP2P) (models/methods/operations) for editing NeRF.

However, relevant models/methods/operations, such as the IP2P and the IN2N, may not confine modifications within local boundaries of regions most relevant to the texts, thus fidelity to the input of the image may not be maintained and unnecessary variability may not be avoided. The IP2P and/or the IN2N may correspond to or may be included in a diffusion model.

In the related art, despite the promising results, diffusion-based image methods may lack a mechanism to automatically localize the edit regions. These methods either ask users for a mask, rely on the global information kept in a noisy input as a starting point, or condition the denoiser on the input. Further, those methods of the related art tend to over-edit. For example, relying on the IP2P to iteratively update NeRF's training dataset, the IN2N over-edits scenes.

To maintain fidelity to the input of the image to be edited and avoid unnecessary variability, it is crucial to confine modifications within local boundaries and naturally prefer parsimonious edits. Thus, there is a need for a solution that keeps changes within the relevant region, so the integrity of the original input is better preserved, while the desired edit is accurately reflected in the output.

Throughout the disclosure, NeRF is discussed. NeRF represents a 3D scene as a neural field, f_{θ}:(x, d)→(c, σ), mapping a 3D coordinate, x∈ [symbol] ³ and a view direction, d∈ [symbol] ², to a colour, c∈[0,1]³, and a density, σ∈ [symbol] ⁺. The field parameters, θ, are optimized to fit the field representation to multiview posed image sets. The field is paired with a rendering operator, implemented as the quadrature approximation of the classical volumetric rendering integral. For a ray, r, parametrized as r=o+td, where o is the origin and d is the view direction, rendering begins with sampling N points, {tᵢ}ᵢ₌₁^{N}, on the ray between a near bound and a far bound. The rendered color is then obtained via the volumetric rendering equation, Ĉ(r)=Σᵢ₌₁^{N}wᵢcᵢ, where wᵢ=Tᵢ(1−exp(−σᵢδᵢ)) is the contribution of the i-th point, δᵢ=tᵢ₊₁−tᵢ are the adjacent point distances, and Tᵢ=exp(−Σⱼ₌₁ⁱ⁻¹σⱼδⱼ) is the transmittance.

Throughout the disclosure, IP2P is discussed. The IP2P is a non-limiting example of denoising diffusion models trained by gradually adding noise to the image in a ‘forward’ diffusion process and estimating this noise and gradually denoising the image in a reverse denoising process. The ‘reverse’ denoising process can also be conditional on text or other signals to guide image synthesis. The IP2P may correspond to or may be included in a diffusion model.

Given an image (I) and a text instruction (C_{T}) describing the edit, the IP2P follows the instruction to edit the image (I). The IP2P is trained on a dataset where for each image (I) and the text instruction (C_{T}), a sample edited image, Iₒᵤₜ, is given. The IP2P is based on ‘latent’ diffusion, where a ‘variational autoencoder’ (VAE) (including an encoder (ε) and a decoder ( [symbol] )) is used for improved efficiency and quality. For a training of IP2P, noise, ϵ˜ [symbol] (0,1), is added to z=ε(Iₒᵤₜ) to get the noisy ‘latent,’ zₜ, where the random timestep, t∈T, determines the noise level.

The denoiser, Ee, is initialized with stable diffusion weights, and fine-tuned to minimize the diffusion objective, [symbol] _{I}_{ₒᵤₜ}_{,I,ϵ,t}[∥ϵ−ϵ_{θ}(zₜ, t, I, C_{T}))∥₂²]. During the training of IP2P, conditions are randomly removed by setting the image I=Ø_{I}, and the text instruction C_{T}=Ø_{T} to further allow unconditional denoising. Thus, the strength of the edit can be controlled by the image guidance scale(s)) and the text guidance scale (s_{T}). Then, the modified score estimate is obtained as:

$${\tilde{ϵ}}_{θ} ( {z}_{t} , t , I , {C}_{T} ) = {ϵ}_{θ} ( {z}_{t} , t , {∅}_{I} , {∅}_{T} ) + {s}_{I} ( {ϵ}_{θ} ( {z}_{t} , t , I , {∅}_{T} ) - {ϵ}_{θ} ( {z}_{t} , t , {∅}_{I} , {∅}_{T} ) )$$

After the training of IP2P, the denoiser can be used to either generate edited images from pure noise, or to iteratively denoise a noisy version of an input image to get an output image. In particular, the reverse diffusion process in the IP2P is conditioned on the editing instruction and an input image to be edited.

‘Latent’ space is a lower-dimensional space that captures the essential features of the input data. Latent space is a compressed representation of the original data where each dimension corresponds to a specific feature or characteristic. This dimensionality reduction is achieved through various techniques, such as autoencoders and variational autoencoders (VAEs), which learn to encode the most important information in the data.

‘Latent space’ and ‘latent field’ are two different but related concepts. The latent space is defined as the space of learned features (e.g., each element of an encoded image). In this disclosure, the latent field is a 3D function, where the input is a 3D position and the output is a latent feature (i.e., an element of the latent space). In other words, the latent field is a way to associate a latent vector (which is an element of or a member of a latent space) to every position in 3D space. Thus, the latent field defines a “3D latent scene”, and therefore, builds on an existing latent space. In some embodiments, the dimensionality of the latent space may be chosen to be lower than the dimensionality of the space from which the data points are drawn, making the construction of latent space an example of dimensionality reduction, which can also be viewed as a form of data compression. E.g., a color image can be mapped into its encoded form (via an AE), which is generally much lower dimensional (note that each “pixel” in the latent image may be higher dimensional, but the number of latent pixels in such a case will tend to be far fewer). The latent field may be usually fit via machine learning, and the latent field may then be used as feature spaces in machine learning models, including classifiers and other supervised predictors.

### SUMMARY

Example embodiments address at least the above problems and/or disadvantages and other disadvantages not described above. Also, the example embodiments are not required to overcome the disadvantages described above, and may not overcome any of the problems described above.

According to an aspect of the disclosure, a method for editing a local area of a target image using a diffusion model, includes: receiving, from a user of an electronic device, an input image; receiving, from the user, a text instruction to edit the input image; generating a relevance map based on the diffusion model and the text instruction; generating a rendered image by performing a relevance guided image editing method on the input image, based on the generated relevance map; and providing, to the user, the generated rendered image. The relevance guided image editing method includes: generating a second noisy image of the input image by adding second noise to the input image by using the diffusion model; generating a third noisy image of the input, which comes from an output of a previous step of a denoising step of the diffusion model; receiving, from an code of the diffusion model, an output image of the third noisy image, which is obtained via the denoising step of the diffusion model; and generating the rendered image by the code based on the relevance map, the second noisy image of the input image, the output image received from the diffusion model.

According to an aspect of the disclosure, a method for editing a local area of a target scene using a diffusion model comprising a Neural Radiance Field (NeRF), includes: receiving, from a user of an electronic device, an input scene comprising a plurality of images and fitting the NeRF to the plurality of images; receiving, from the user of the electronic device, an text instruction to edit the input scene; generating a plurality of relevance maps respectively corresponding to the plurality of images, and generating a relevance field by fitting the NeRF to the plurality of relevance maps; generate an edited scene by performing a relevance guided scene editing method, based on the input scene, the text instruction, and the generated relevance field; and providing, to the user of the electronic device, the edited scene. The relevance guided scene editing method includes: generating an edited image and a updated relevance map corresponding to the edited image by performing a relevance guided image editing method on an original image of the plurality of images and a rendered image obtained from the fitted NeRF, based on the text instruction and a relevance map obtained from the relevance field, and updating the NeRF and the relevance field with the generated edited image and the updated relevance map. The relevance guided image editing method includes: generating a second noisy image of the original image by adding second noise to the original image by using the diffusion model; generating a third noisy image of the original image, which comes from an output of a previous step of a denoising step of the diffusion model; receiving, from an code of the diffusion model, an output image of the third noisy image, which is obtained via the denoising step of the diffusion model for the third noisy image; and generating the edited image by the code based on the relevance map, the second noisy image of the original image, the output image from the code.

According to an aspect of the disclosure, an electronic device for editing a local area of a target image using a diffusion model, includes: at least one processor; and at least one memory configured to store instructions which, when executed by the at least one processor, cause the at least one processor to: receive, from a user of the electronic device, an input image; receive, from the user, a text instruction to edit the input image; generate a relevance map based on the diffusion model and the text instruction; generate a rendered image by performing a relevance guided image editing method on the input image, based on the generated relevance map; and provide, to the user, the generated rendered image. The relevance guided image editing method, performed by the at least one processor, includes: generating a second noisy image of the input image by adding second noise to the input image by using the diffusion model; generating a third noisy image of the input, which comes from an output of a previous step of a denoising step of the diffusion model; receiving, from a code of the diffusion model, an output image of the third noisy image, which is obtained via the denoising step of the diffusion model; and generating the rendered image by the code based on the relevance map, the second noisy image of the input image, the output image received from the diffusion model.

### BRIEF DESCRIPTION OF THE DRAWINGS

The above and other aspects and features of embodiments of the disclosure will be more apparent from the following description taken in conjunction with the accompanying drawings, in which:

FIG. 1 illustrates an electronic device that may be used in implementing one or more embodiments of the disclosure;

FIG. 2 illustrates operations of obtaining a relevance map by using InstructPixel2Pixel (IP2P) in accordance with one or more embodiments of the disclosure;

FIG. 3 illustrates operations for a ‘relevance guided image editing method’ in accordance with one or more embodiments of the disclosure;

FIG. 4 illustrates an overview of a ‘relevance guided scene editing method’ in accordance with one or more embodiments of the disclosure;

FIG. 5 illustrates operations for the relevance guided image editing method in accordance with one or more embodiments of the disclosure;

FIG. 6 illustrates operations for the relevance guided scene editing method in accordance with one or more embodiments of the disclosure; and

FIG. 7 illustrates one diffusion process of the relevance guided image editing method in accordance with one or more embodiments of the disclosure; and

FIG. 8 illustrates one diffusion process of the relevance guided scene editing method in accordance with one or more embodiments of the disclosure.

### DETAILED DESCRIPTION

Example embodiments are described in greater detail below with reference to the accompanying drawings. In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another. The term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods are not limited to the implementations. Thus, the operation and behavior of the systems and/or methods are described herein without reference to specific software code, it being understood that software and hardware may be designed to implement the systems and/or methods based on the descriptions herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

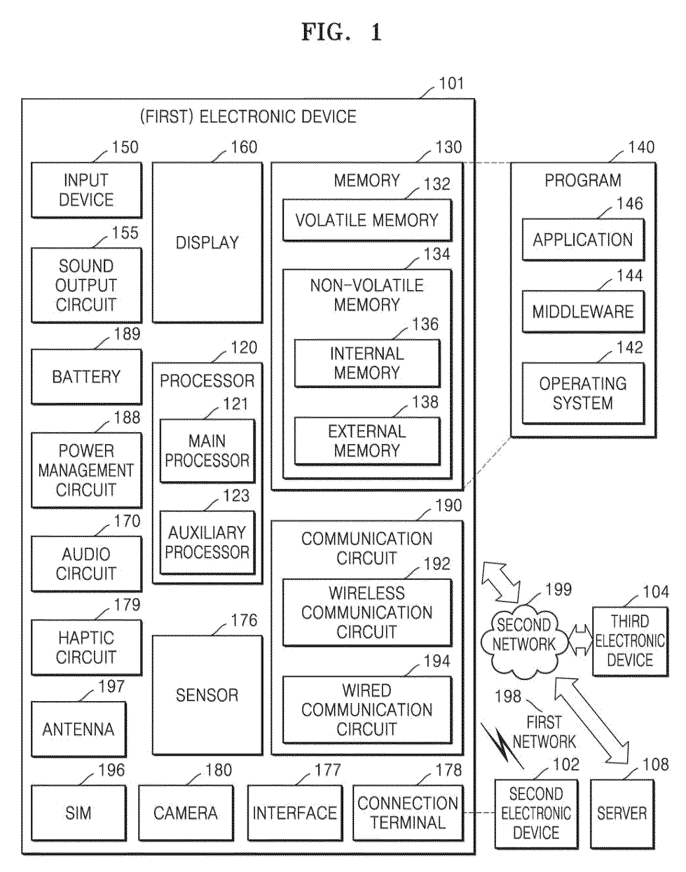

FIG. 1 illustrates example components of the electronic device in accordance with some embodiments of the disclosure.

In FIG. 1, a (first) electronic device 101 may communicate with a second electronic device 102 via a first network 198 (e.g., a short-range wireless communication network), or a third electronic device 104 or a server 108 via a second network 199 (e.g., a long-range wireless communication network). In one embodiment, the (first) electronic device 101 may communicate with the third electronic device 104 via the server 108. Throughout the disclosure, the first electronic device 101 may be referred to as ‘the electronic device 101.’ Hereinafter, components of the electronic device 101 are described. Those components of the electronic device 101 may be also included in the second electronic device 102 or the third electronic device 104. The first electronic device 101, the second electronic device 102, or the third electronic device 104 may be configured to perform methods, steps, or operations described in the disclosure.

In one embodiment, the electronic device 101 may include a processor 120, memory 130, an input device 150, a sound output circuit 155, a display 160, an audio circuit 170, a sensor 176, an interface 177, a haptic circuit 179, a camera 180, a power management circuit 188, a battery 189, a communication circuit 190, a subscriber identification module (SIM) 196, or an antenna 197.

In some embodiments, at least one (e.g., the display 160, the sensor 176, or the camera 180) of the components may be omitted from the electronic device 101, or one or more other components may be added in the electronic device 101. In some embodiments, some of the components may be implemented as single integrated circuitry. For example, the sensor 176 (e.g., a fingerprint sensor, an iris sensor, or an illuminance sensor) may be implemented as embedded in the display 160 (e.g., a display). In an embodiment, the electronic device 101 may be a user equipment, a user terminal, a smartphone, a tablet personal computer (PC), a laptop, and/or a PC.

The processor 120 may execute, for example, software (e.g., a program 140) to control at least one other component (e.g., a hardware or software component) of the electronic device 101 coupled with the processor 120, and may perform various data processing or computation. In one embodiment, as at least part of the data processing or computation, the processor 120 may load a command or data received from another component (e.g., the sensor 176 or the communication circuit 190) in volatile memory 132, process the command or the data stored in the volatile memory 132, and store resulting data in non-volatile memory 134. In one embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The processor 120 may refer to or correspond to one or more processors. For example, the electronic device 101 may include two or more processors like the processor 120. In an embodiment, the main processor 121 and the auxiliary processor 123 may comprise processing circuitry.

The auxiliary processor 123 may be implemented as separate from, or as part of the main processor 121. The auxiliary processor 123 may control at least some of functions or states related to at least one component (e.g., the display 160, the sensor 176, or the communication circuit 190) among the components of the electronic device 101, instead of the main processor 121 while the main processor 121 is in an inactive (e.g., sleep) state, or together with the main processor 121 while the main processor 121 is in an active state (e.g., executing an application). In one embodiment, the auxiliary processor 123 (e.g., an image signal processor or a communication processor) may be implemented as part of another component (e.g., the camera 180 or the communication circuit 190) functionally related to the auxiliary processor 123.

The memory 130 may store various data used by at least one component (e.g., the processor 120 or the sensor 176) of the electronic device 101. The various data may include, for example, software (e.g., the program 140) and input data or output data for a command related thereto. The memory 130 may include the volatile memory 132 or the non-volatile memory 134. The program 140 may be stored in the memory 130 as software, and may include, for example, an operating system (OS) 142, middleware 144, or an application 146.

One or more embodiments of the disclosure may be implemented as software (e.g., the application 146, the middleware 144, the operating system 142) including one or more instructions that are stored in the memory 130 (comprising one or more storage medium) that is readable by the electronic device 101.

For example, the processor 120 of the electronic device 101 may invoke at least one of the one or more instructions stored in the memory 130, and execute the at least one of the one or more instructions, with or without using one or more other components under the control of the processor 120. This allows the electronic device 101 to be operated to perform at least one function according to the at least one instruction invoked. The one or more instructions may include a code generated by a compiler or a code executable by an interpreter. The memory 130, which may be a machine-readable storage medium, may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the memory 130 (the storage medium) and where the data is temporarily stored in the memory 130. In some embodiments, the electronic device 101 may comprise one or more processors (e.g., the main processor 121 and the auxiliary processor 123), and the one or more instructions may be executed by the one or more processors individually or collectively, thereby causing the electronic device 101 to perform any combination of one or more operations (or functions, steps) described herein.

In some embodiments, functions related to artificial intelligence (AI) are operated by the processor 120 (or the main processor 121 or the auxiliary processor 123) and the memory 130. The processor 120 (or the main processor 121 or the auxiliary processor 123) may include or may correspond to a general-purpose processor, such as a CPU, an application processor, or a digital signal processor (DSP), a graphics-dedicated processor, such as a graphics processing unit (GPU) or a vision processing unit (VPU), or an artificial intelligence-dedicated processor, such as a neural processing unit (NPU). The processor 120 (or the main processor 121 or the auxiliary processor 123) may control input data to be processed according to predefined operation rules or artificial intelligence models, which are stored in the memory 130. Alternatively, the processor 120 (or the main processor 121 or the auxiliary processor 123) may be an artificial intelligence-dedicated processor including a hardware structure specialized for processing of an artificial intelligence model.

The predefined operation rules or the artificial intelligence models are made through training. Here, the statement of being made through training means that a basic artificial intelligence model is trained by a learning algorithm by using a large number of training data, thereby making a predefined operation rule or an artificial intelligence model, which is configured to perform a desired characteristic (or purpose). Such training may be performed in a device itself, in which artificial intelligence according to the disclosure is performed, or may be performed via a separate server or a separate system. Examples of the learning algorithm may include, but are not limited to, supervised learning, unsupervised learning, semi-supervised learning, and reinforcement learning.

The artificial intelligence model may include a plurality of neural network layers. Each of the plurality of neural network layers has a plurality of weight values and performs neural network calculations through calculations between a calculation result of a previous layer and the plurality of weight values. The plurality of weight values of the plurality of neural network layers may be optimized by a training result of the artificial intelligence model. For example, the plurality of weight values may be updated to minimize a loss value or a cost value, which is obtained from the artificial intelligence model during the process of training. An artificial neural network may include a deep neural network (DNN), and examples of the artificial neural network may include, but are not limited to, a random forest model, a convolutional neural network (CNN), a DNN, a recurrent neural network (RNN), a restricted Boltzmann machine (RBM), a deep belief network (DBN), a bidirectional recurrent deep neural network (BRDNN), and deep Q-Networks.

The input device 150 may receive a command or data to be used by another component (e.g., the processor 120) of the electronic device 101, from the outside (e.g., a user, the second electronic device 102, or the third electronic device 104) of the electronic device 101. The input device 150 may include, for example, a microphone, a mouse, a keyboard, a key (e.g., a button), or a digital pen (e.g., a stylus pen).

The sound output circuit 155 may output sound signals to the outside of the electronic device 101. The sound output circuit 155 may include, for example, a speaker or a receiver. The speaker may be used for general purposes, such as playing multimedia or playing recorded data. The receiver may be used for receiving incoming calls. According to some embodiments, the receiver may be implemented as separate from, or as part of the speaker.

The display 160 may visually provide information to the outside (e.g., a user) of the electronic device 101. The display 160 may include, for example, a display device, a hologram device, or a projector and control circuitry to control a corresponding one of the display device, hologram device, and projector. According to some embodiments, the display 160 may include a touch sensor adapted to detect a touch, or a pressure sensor adapted to measure the intensity of force incurred by the touch.

The audio circuit 170 may convert a sound into an electrical signal and vice versa. According to some embodiments, the audio circuit 170 may obtain the sound via the input device 150 or output the sound via the sound output circuit 155 or a headphone of an external electronic device (e.g., the second electronic device 102 or the third electronic device 104) directly (e.g., wiredly) or wirelessly coupled with the electronic device 101.

The sensor 176 may detect an operational state (e.g., power or temperature) of the electronic device 101 or an environmental state (e.g., a state of a user) external to the electronic device 101, and then generate an electrical signal or data value corresponding to the detected state. The interface 177 may support one or more specified protocols to be used for the electronic device 101 to be coupled with the external entity (e.g., the second electronic device 102, the third electronic device 104, or the server 108) directly (e.g., wiredly) or wirelessly. According to some embodiments, the interface 177 may include, for example, a high-definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the second electronic device 102, the third electronic device 104, or the server 108). According to some embodiments, the connecting terminal 178 may include, for example, an HDMI connector, a USB connector, an SD card connector, or an audio connector (e.g., a headphone connector).

The haptic circuit 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera 180 may capture a still image or moving images (or a set or one or more still images, or video data). According to some embodiments, the camera 180 may include one or more lenses, image sensors, ISPs, or flashes. In some embodiments, the camera may obtain (or capture) a single still image of a 2D (2-dimensional) or 3D scene, or a set of one or more still images of the 2D (2-dimensional) or 3D scene, and provide the obtained (or captured) still image(s) to the processor 120 or the memory 130. The processor 120 may perform one or more operations described herein to the obtained image(s). The memory 130 may store the obtained image(s) and provide the obtained image(s) to the processor 120 in response to a request from the processor 120.

The power management circuit 188 may manage power supplied to the electronic device 101. According to some embodiments, the power management circuit 188 may be implemented as at least part of, for example, a power management integrated circuit (PMIC).

The battery 189 may supply power to at least one component of the electronic device 101. According to some embodiments, the battery 189 may include, for example, a primary cell which is not rechargeable, a secondary cell which is rechargeable, or a fuel cell.

The communication circuit 190 may support establishing a direct (e.g., wired) communication channel or a wireless communication channel between the electronic device 301 and the external entity (e.g., the second electronic device 102, the third electronic device 104, or the server 108) and performing communication via the established communication channel. The communication circuit 190 may include one or more communication processors (CPs) that are operable independently from the processor 120 (e.g., an application processor) and supports a direct (e.g., wired) communication or a wireless communication. According to some embodiments, the communication circuit 190 may include a wireless communication circuit 192 (e.g., a cellular communication module, a short-range wireless communication module, or a global navigation satellite system (GNSS) communication module) or a wired communication circuit 194 (e.g., a local area network (LAN) communication module or a power line communication (PLC) module). A corresponding one of these communication modules may communicate with the external electronic device via the first network 398 (e.g., a short-range communication network, such as Bluetooth™, Wi-Fi direct, or IR data association (IrDA)) or the second network 399 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication circuit 192 may identify and authenticate the electronic device 101 in a communication network, such as the first network 198 or the second network 199, using subscriber information (e.g., international mobile subscriber identity (IMSI)) stored in the SIM 196.

The antenna 197 may transmit or receive a signal or power to or from the outside (e.g., an external electronic device) of the electronic device 101. According to an embodiment, the antenna 197 may include an antenna including a radiating element composed of a conductive material or a conductive pattern formed in or on a substrate (e.g., a printed circuit board (PCB)). According to an embodiment, the antenna 197 may include a plurality of antennas (e.g., array antennas).

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Operations described in the disclosure may be performed by the processor 120, the memory 130, or the program 140, alone or in combination. Throughout the disclosure, InstructPix2Pix (IP2P) is discussed as an example of a denoising diffusion model. However, any diffusion model trained to condition on text input for image editing may be adapted to the embodiments of the disclosure.

Text-to-image diffusion models may generate high-quality images based on captions. Moreover, pre-trained diffusion models may be used to edit images based on text description. Some diffusion models may tend to over-edit images, including parts irrelevant to the text description (or instruction). Simply increasing the image guidance scale or reducing the text instruction (or guidance) scale may cause adverse effects on a region of images that actually should be edited.

The disclosure is directed to an approach to predict a scope of an image (two dimensional, 2D) or a scene (three dimensional, 3D) to be edited, which is implicit in an ‘edit instruction’ that may be provided by a user. The disclosure proposes finding a discrepancy between a first noise prediction by the IP2P conditioned on the instruction (in other words, with text instructions or text commands) and a second noise prediction by the IP2P with no text (in other words, an empty text box).

The disclosure may provide an approach to an automatic localization of an edit based on a single (text) instruction. For example, the instruction may not specify what kind, where in an input image, or to what extent an editing should occur. The disclosure may provide a method of noting a minimal edit (e.g., a minimal scope of edit) corresponding to the instruction. For example, according to the approach of the disclosure, a special scope implicit in the instruction may be predicted, via a discrepancy between noise predictions conditioned on the instruction versus empty text (e.g., without the instruction). Accordingly, a region of edit may be automatically localized.

Throughout the disclosure, the discrepancy between the first noise prediction and the second noise prediction may be referred to as or may be represented by a ‘relevance map.’ In some embodiments, ‘binarizing’ the ‘relevance map’ gives the mask of the region that may be edited. Throughout the disclosure, ‘binarizing’ means converting a real-valued number (e.g., 0.2, 0.7, 1.8) of the relevance map to a binary relevance mask (zero (0) or one (1)). In some embodiments, if the real-valued number is above a threshold (e.g., one (1)), then the real-valued number is converted to one (1). If the real-valued number is equal to or below the threshold, then the real-valued number is converted to zero (0).

In some embodiments, the denoising process of the IP2P may be improved (or modified) not to change the unmasked pixels. In standard IP2P, all the noisy latent pixels (from the previous operation) are passed to the denoiser to obtain a less noisy latent image. Instead, in some embodiments of the disclosure, the unmasked latent pixels are replaced with the noisy latent pixels from the forward diffusion process, which have not undergone editing.

In some embodiments, for NeRF editing by iterative dataset updates, a ‘relevance map’ is used to localize the edits. Note that, across different views, the relevance maps can be slightly inconsistent. To ensure 3D consistency, the disclosure proposes training a ‘field’ on the relevance map from training views. For example, according to the disclosure, a multiview-consistent 3D relevance field may be constructed by combining relevance maps across views, enabling localized 3D scene translation. Throughout the disclosure, the ‘field’ may be referred to as a ‘relevance field.’

Then, rendered views from the relevance field are binarized (normalized) and used as ‘masks’ for editing training views of the 3D scene. The disclosure targets to achieve state-of-the art performance on both of a first task of editing the image and a second task of editing the 3D scene using NeRF.

First, the disclosure proposes finding the relevance map to predict the scope of an editing instruction on an image. Second, the disclosure proposes using the relevance maps to localize instruction-based image editing. Third, the disclosure proposes lifting the maps into 3D by the relevance field to use the localization in scene editing. That is, the disclosure proposes constructing a 3D version of relevance maps, which is called herein as a ‘relevance field.’

In some embodiments, the relevance map may be defined as a discrepancy between a conditional and an unconditional pass over a diffusion-based image editor. The relevance is used as a mask to guide an image generation process and force the unmasked pixels not to change, resulting in a localized image editor. The relevance field on the relevance maps of the training vies of a NeRF may achieve similar localizations when editing 3D scenes.

Operations for obtaining the relevance map are described herein.

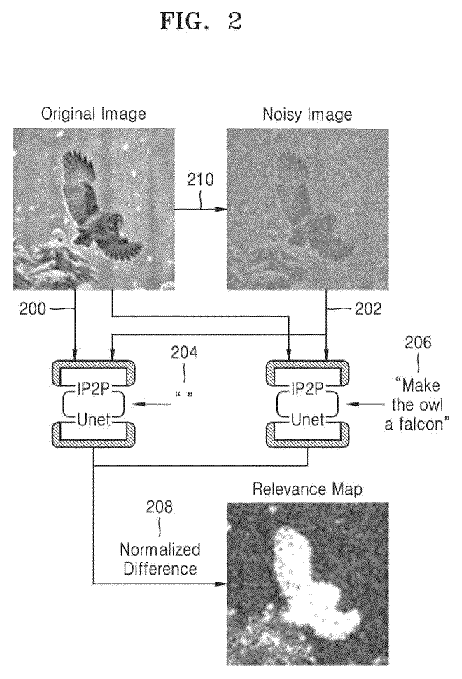

FIG. 2 illustrates operations of obtaining the relevance map by using the IP2P in accordance with one or more embodiments of the disclosure. In FIG. 2, at operation 210, a noisy image is obtained from an original image (here, an image illustrating a flying owl) using IP2P. In an embodiment, operation 210 corresponds to an intermediate diffusion step of IP2P.

At operation 200, the pixels of the ‘original image’ are input to a first IP2P Unet 204 ‘without any text’ and to a second IP2P Unet 206 ‘with a text instruction’ (“Make the owl a falcon”). The first IP2P Unet is a noise prediction part of the first IP2P.

Throughout the disclosure (e.g., FIG. 2), a set of IP2P Unets (the first IP2P Unet and the second IP2P Unet) is shown and described. In some embodiments, the first IP2P Unet and the second IP2P Unet may be the same Unet. In some other embodiments, the first IP2P Unet and the second IP2P Unet may be different.

At operation 202, the pixels of the ‘noisy image’ are input to the first IP2P Unet and to the second IP2P 206.

At operation 208, a difference between a first output from the first IP2P Unet 204 and a second output from the second IP2P Unet 206 is obtained. The ‘relevance map’ is obtained by normalizing (or ‘binarizing’) the difference. The ‘relevance map’ may be used as a mask for editing.

In some embodiments, given an image (I) and an edit instruction (C_{T}), the IP2P is used to predict the relevance of each pixel to the edit, i.e., the likelihood that a given pixel needs to be changed, based on an editing task.

First, noise is added to the encoded image (ε(I)), until a fixed timestep (tᵣₑₗ), to obtain the noisy latent,

$${z}_{{t}_{rel}} = \sqrt{{α}_{{t}_{re1}}} ε ( I ) + \sqrt{1 - {α}_{{t}_{rel}}} ϵ$$

Here, ϵ˜ [symbol] (0,1) is a random noise, and at is the noise scheduling factor at timestep t. Note that tᵣₑₗ may be a constant noise level used, in this disclosure, as a hyper parameter. For example, tᵣₑₗ may be 0.8. Then, IP2P's (noise prediction) Unet (ϵ_{θ}) is used to get two different predictions: i) the predicted noise conditioned on both the image and the text, ϵ_{I,T}(zₜ_{ᵣₑₗ})=ϵ_{θ}(zₜ_{ᵣₑₗ}, tᵣₑₗ, I, C_{T}), and ii) the predicted noise conditioned only on the image and the empty text as the instruction, ϵ_{θ}(zₜ_{ᵣₑₗ})=ϵ_{θ}(zₜ_{ᵣₑₗ}, tᵣₑₗ, I, “ ”). The difference between ϵ_{I,T}(zₜᵣₑ) and ϵ_{I}(zₜ_{ᵣₑₗ}) is that only the former is aware of the text prompt. The magnitude of the mismatch between these two values is used as a measurement of the relevance of each pixel to the edit. To this end, the absolute difference between the two values is first obtained. The absolute difference is referred to as the ‘relevance map’:

$${ℛ}_{x , I , T} = \vert {ϵ}_{I , T} ( {z}_{{t}_{rel}} ) - {ϵ}_{I} ( {z}_{rel} ) \vert$$

In some embodiments, for robustness, the outlier values may be further clamped using interquartile range (IQR) with ratio 1.5, and the relevance map may be normalized between 0 and 1.

The relevance guided image editing method are described herein.

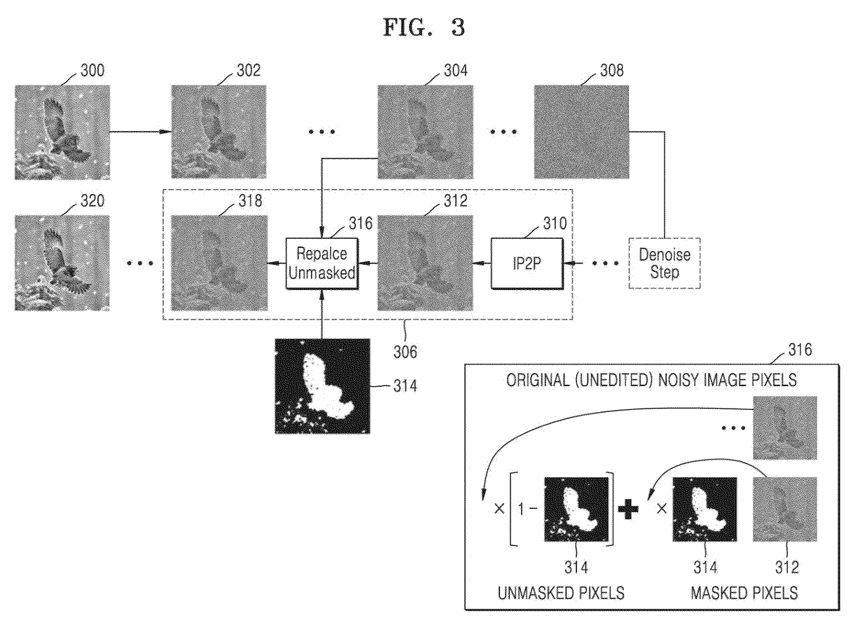

FIG. 3 illustrates the relevance guided image editing method in accordance with one or more embodiments of the disclosure.

At operation 300, 302, 304, . . . , and 308, which correspond to forward processing operations of IP2P, noises are added to the original latent image input at operation 300.

At operation 310 (one of the denoising operations of IP2P), the IP2P receives a latent image with noises and generates an output image 312.

At operation 316, the relevance mask (the relevance map) 314 is applied to the output image 312 of IP2P.

At operation 316, the unmasked pixels (1−the relevance mask 314) is applied to an image 304, which is one of the images processed during the forward processing operations of IP2P.

As shown in the right-cornered box of FIG. 3, the unmasked pixels and the masked pixels are combined to generate the image 318. After more operations for the denoising are performed on the image 318, a final image 320 is obtained.

The disclosure proposes using the ‘relevance map’ to guide generation of the edited image, and to localize the edited region. In the relevance map, a high relevance value for a pixel means that the pixel is likely to be relevant to the edit. In contrast, a low relevance map value of a pixel indicates that the pixel is unlikely to require change.

The disclosure applies a mask threshold, τ∈[0,1], on the relevance map, to get the edit mask, [symbol] _{x,I,T}= [symbol] ( [symbol] _{x,I,T}≥τ), enclosing the pixels to be edited. Setting τ as 0 may result in every pixel being masked, which is equivalent to IP2P. Generally, increasing an image guidance scale is insufficient to localizing the IP2P edits; instead, it merely weakens the overall edit itself (e.g., reducing text-image similarity). On the other hand, changing t provides a different form of control to a user, and allows user to control the edited region, without negatively impacting regions that do not need modification.

To edit an encoded input image (x), the encoded image (ε(x)) is diffused to a fixed noise level (t_{edit}) to get the starting noisy latent, zₜ_{_{edit}}. The edit noise level (t_{edit}) determines the strength of the edit. Setting the edit noise level (t_{edit}) to zero (0) results in the input image being unchanged. In contrast, setting the edit noise level (t_{edit}) to the maximum diffusion timestep starts the generation from pure noise.

Each denoising stage takes a noisy latent, zₜ, and denoises the noisy latent to get zₜ₋₁. The denoising step begins with predicting the noise via the IP2P (operation 310) to get \tilde{ϵ}ₜ=\tilde{ϵ}_{θ}(zₜ, t, I, C_{T}). Using \tilde{ϵ}ₜ and the denoising diffusion implicit models (DDIM) procedure, the mask-unaware prediction at timestep t−1 is

$${\tilde{z}}_{t - 1} = \sqrt{{α}_{t - 1}} ( \frac{{z}_{t} - \sqrt{1 - {α}_{t}} {\tilde{ϵ}}_{t}}{\sqrt{{α}_{t}}} ) + \sqrt{1 - {α}_{t - 1}} {\tilde{ϵ}}_{t}$$

The unedited noisy latent of the input image, x, at timestep t−1 would have been \hat{z}ₜ₋₁=\sqrt{αₜ₋₁}ε(x)+\sqrt{1−αₜ₋₁}ϵ. To obtain zₜ₋₁, the mask unaware prediction, \tilde{z}ₜ₋₁, is combined with the unedited noisy latent, \hat{z}ₜ₋₁, as

$${z}_{t - 1} = {\tilde{z}}_{t - 1} {ℳ}_{x , I , T} + {\hat{z}}_{t - 1} ⊙ ( 1 - {Μ}_{x , I , T} )$$

That is, by replacing the unmasked pixels with the noisy version of the input image, the disclosure proposes restraining the generation process from changing any pixel outside of the mask. After iterative denoising, the edited image, [symbol] (z₀), is obtained.

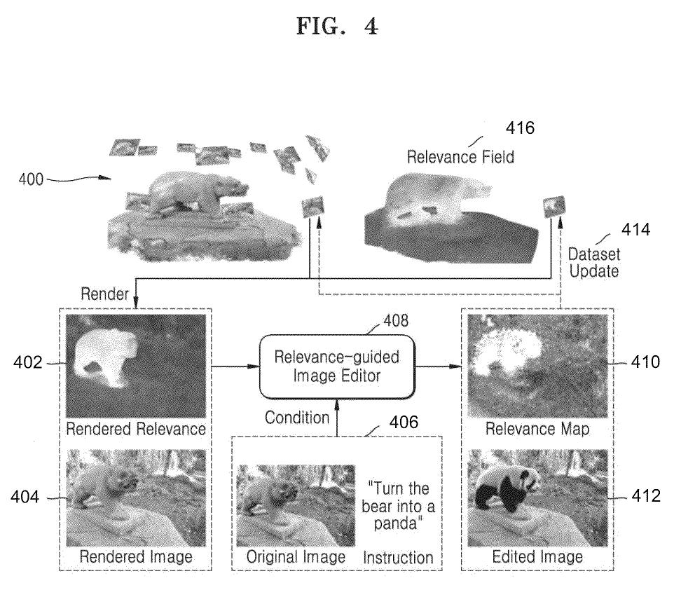

The relevance guided scene editing method is described herein. FIG. 4 illustrates the relevance guided scene editing method in accordance with one or more embodiments of the disclosure.

At operation 400, a 3D scene is obtained by collecting multiple (random) input views (images) about an object (such as a bear shown in FIG. 4).

At operation 416, an (initial) relevance field is generated from multiple relevance maps (e.g., shown in FIG. 3 and discussed above).

Given a rendered relevance map 402 (from the relevance field) and a rendered image 404, the relevance-guided image editor 408 (the editing operations shown in FIGS. 2, 3 and discussed above) is used to obtain a new relevance map 410 and an edited image 412 of an original image 406, based on an instruction (e.g., “Turn the bear into a panda”) provided to the relevance-guided image editor 408.

In some embodiments, the relevance-guided image editor 408 may correspond to a whole process of image encoding, creating multiple noisy version of the latent images, running multiple 316 operations, image decoding, and additional operations for obtaining a relevance map (shown in FIG. 2).

At operation 414, the relevance map 410 and the edited image 412 (the outputs of the relevance-guided image editor 408) are used to update the NeRF 400 and the relevance field 416.

The above described operations for the original image 406 may be repeated for other original images and other text instructions. Then, more relevance maps and edited images may be used to further update the NeRF 400 and the relevance field 416.

In some embodiments, an automated localization of an edit based on a text instruction may be provided. According to the automated localization of the disclosure, the mask for editing (e.g., a relevance map) may be continuously tunable by controlling a threshold of the mask. The automated localization of the disclosure may provide easier way of creating suitable mask for user comparing to creating a mask manually using some prompts. The automated localization of the disclosure may be also applied to 3D scene. The automated localization of the disclosure may further be easy to be integrated into learning (or training) pipelines, whereas manual-creating masks are not scalable.

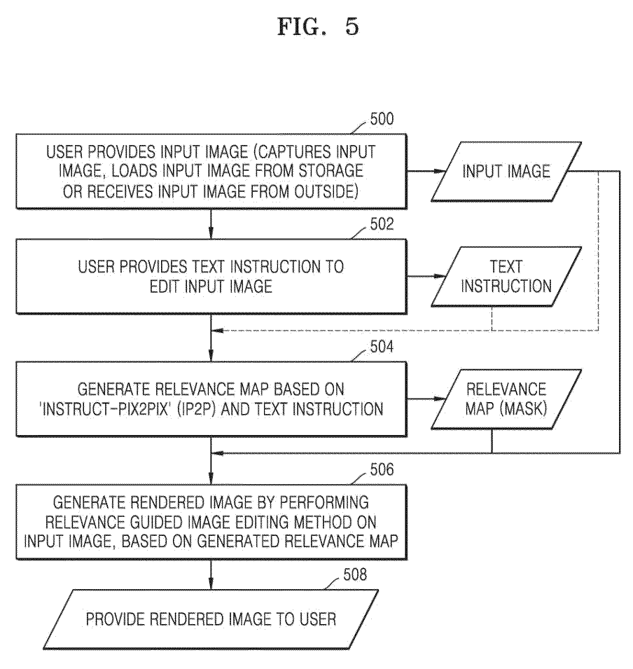

FIG. 5 illustrates the relevance guided image editing method in accordance with one or more embodiments of the disclosure.

At operation 500, a user provides an input image to an improved IP2P (model/operations/method). The improved IP2P may correspond to or may be included in a diffusion model. For example, the user captures the input image by the camera 180 of the electronic device 101, loads the input image from a storage of the electronic device 101, or receives the input image from an outside of the electronic device. The improved IP2P may be included in or may correspond to a diffusion model.

At operation 502, the user provides, to the improved IP2P, a text instruction to edit the input image. In an embodiment, the text instruction may correspond to an instruction generated by a speech-to-text operation. That is, the user may speak an instruction at the electronic device 101, rather than typing the instruction on the display 160 of the electronic device 101.

Although FIG. 5 illustrates that operation 502 is performed after operation 500 is performed, the order is an example. In some other embodiments, operation 500 is performed after operation 502 is performed. In some other embodiments, operation 500 and operation 502 are performed substantially simultaneously.

At operation 504, a relevance map (a relevance mask) is generated, for example, by running one denoising step of the IP2P with the text instruction and without the instruction, and comparing the resulted pixels. In some embodiments, the relevance map is generated based on IP2P (Unet) and the text instruction. In some embodiments, the relevance map represents the differences between a first set of pixels generated by running (one denoising step of) the IP2P with the text instruction and a second set of pixels generated by running (one denoising step of) the IP2P without the text instruction.

In some embodiments, the IP2P includes a first IP2P Unet and a second IP2P Unet. The operation of generating the relevance map, based on the IP2P and the text instruction, includes: generating a first noisy image of the input image by adding first noise to the input image by using the diffusion model; inputting the input image and the first noisy image to a first IP2P Unet without any text instruction and inputting the input image and the first noisy image to a second IP2P Unet with a text instruction; obtaining a difference between a first output of the first IP2P Unet and a second output of the second IP2P Unet; and normalizing the obtained difference.

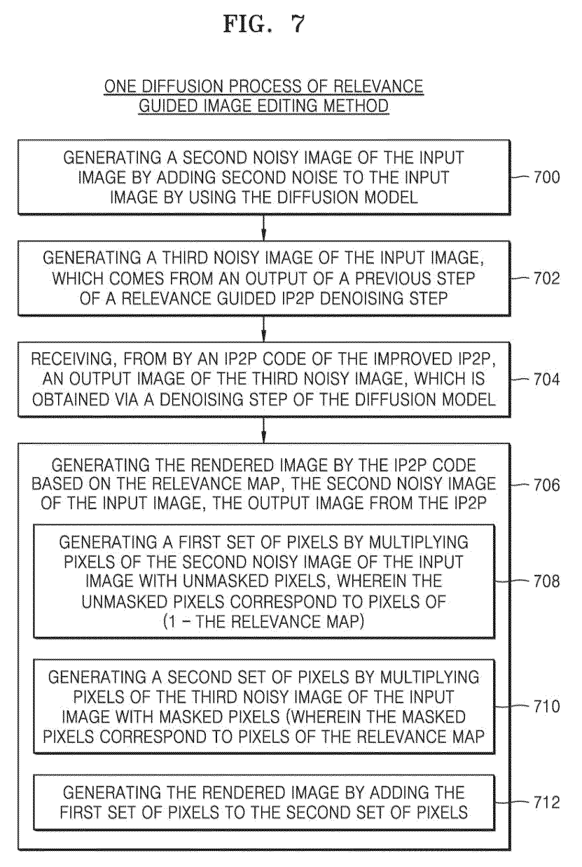

At operation 506, the relevance guided image editing method (operation) is performed using the improved (modified) IP2P and the estimated relevance map. In some embodiments, the relevance guided image editing method may include operations shown in FIGS. 2 and 3 and described above. In some embodiments, a rendered image is generated by performing the relevance guided image editing method on the input image, based on the generated relevance map. In some embodiments, the relevance guided image editing method may include operations shown in FIG. 7, which correspond to one diffusion process of multiple diffusion processes, and described below.

At operation 508, the rendered image is provided to the user. In some embodiments, the rendered image is shown in the display 160 of the electronic device 101.

In some embodiments, as shown in FIG. 3 and described above, the relevance guided image editing method includes:
1) applying the original (unedited) noisy image pixels 304 to the unmasked pixels (in a region outside of the relevance map 314, which is ‘1−the masked pixels’),
2) applying the relevance map 314 to the image 312 (which is an output of I2P2 310), and
3) combining the outcome of the 1) operation and the 2) operation. Those operations of the relevance guided image editing method are performed at each denoising step.

In some embodiments, the IP2P may be used as the backbone of the editing method, and may be conditioned on the initial captures from the scene. This may prevent drastic drifts from the original scene in the recurrent synthesis process. The relevance guided image editing method (described above regarding FIG. 3) may return an edited image and an updated relevance map, which are used to update the corresponding training views for the NeRF and the relevance field, respectively.

The proposed method of localizing the edits based on relevance maps can be extended to editing 3D scenes, as described below. Given a multiview capture, {Iᵢ}ᵢ₌₁ⁿ, of a static scene and the corresponding camera poses, the goal is to edit a NeRF, f_{θ}, fitted (trained) to the scene according to a text prompt, C_{T}.

The disclosure proposes performing iterative training view updates by replacing one training view, Iₜ, at a time by an edited counterpart of the one training view, according to a text prompt, C_{T}. To ensure the consistency of the localization of edits across different views, the disclosure proposes fitting a 3D neural field, which is referred as a ‘relevance field,’ to the relevance maps of all the training views.

While editing each of the views, the corresponding relevance map may be rendered from the relevance field to guide the edit

To implement the relevance field, the disclosure proposes extending the NeRF (f_{θ}) to return a view-independent relevance, r(x)∈[0,1], for every point, x, in the 3D space. Notice that the geometry of the main NeRF and the relevance field is shared, and when fitting the relevance field, the disclosure proposes detaching the gradients of the densities to ensure that the potential inconsistencies do not affect the geometry of the main scene. For a ray, r, the rendered relevance, \hat{R}(r), may be obtained by replacing the point-wise colors with relevance values in the volumetric rendering equation, as \hat{R}(r)=Σᵢ₌₁^{N}wᵢrᵢ.

During the NeRF editing process, every n_{edit} iterations, we randomly sample a training view Iᵢ. The first time the training view (Iᵢ) is sampled, the relevance map, R_{I}_{ᵢ}_{I,T}, is obtained and added to the training data of the relevance field. From the same view, the image, Îᵢ, and the relevance map, \hat{R}ᵢ, are rendered using the NeRF (f_{θ}). The relevance guided image editing method (described above regarding FIG. 3) is used to locally edit Îᵢ, conditioned on the original captured image, Iᵢ, and the text condition, C_{T}. To this end, the encoded rendered image, ε(Îᵢ), is diffused until a random timestep, t_{edit}∈T, to obtain zₜ_{_{edit}}. The noisy latent, zₜ_{_{edit}}, is iteratively denoised conditioned on the original unedited view, Iᵢ, and the text prompt, C_{T}, guided by the rendered relevance map, \hat{R}ᵢ, to obtain the edited training view, Ĩᵢ= [symbol] (z₀). Since the several-fold upsampling induced by the decoder could lead to inconsistencies in the unedited region, the disclosure proposes replacing the unedited RGB pixels in Ĩᵢ with their counterparts from Iᵢ using a relevance mask rendered in the original image resolution. After editing, Ĩᵢ replaces the corresponding training view to supervise the main NeRF (the color field).

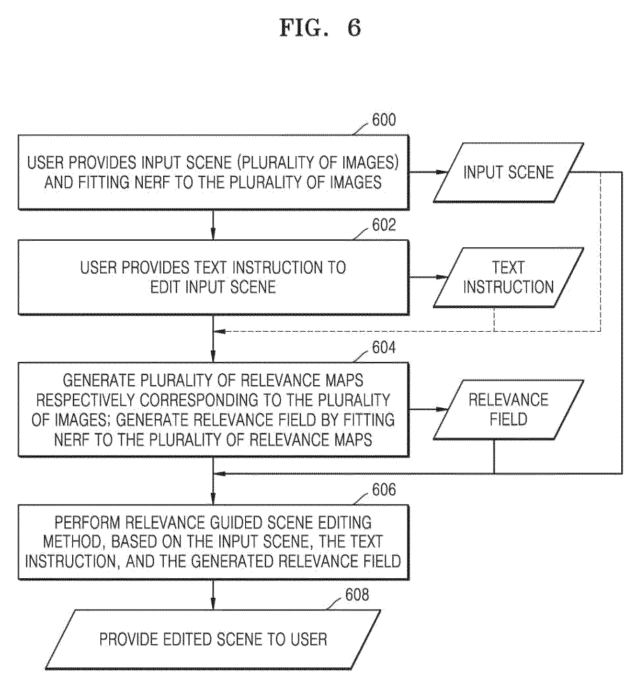

FIG. 6 illustrates operations for the relevance guided scene editing method in accordance with one or more embodiments of the disclosure.

At operation 600, a user captures a scene by collecting a plurality of images (‘N’ images) and by fitting a NeRF to those images. As a result, an input scene is obtained from the fitted NeRF. In some embodiments, the user provides (e.g., to an electronic device implementing the improved IN2N) an input scene (3D) (about an object) including a plurality of 2D images, and then, the electronic device may fit the NeRF to the plurality of 2D images. That is, the NeRF is fitted to unedited source views (the plurality of 2D images).

At operation 602, the user provides (e.g., to an electronic device implementing the improved IN2N) a text instruction to edit the input scene. In an embodiment, the text instruction may correspond to an instruction generated by a speech-to-text operation. That is, the user may speak an instruction at the electronic device 101, rather than typing the instruction on the display 160 of the electronic device 101. Although FIG. 6 illustrates that operation 602 is performed after operation 600 is performed, the order is an example. In some other embodiments, operation 600 is performed after operation 602 is performed. In some other embodiments, operation 600 and operation 602 are performed substantially simultaneously.

At operation 604, a relevance map is obtained for each view. A relevance field is generated (estimated) by fitting the NeRF to the relevance map for each view. In some embodiments, the NeRF is fitted to a plurality of relevance maps and corresponding images for multiple views of the object. In some embodiments, a plurality of relevance maps is generated, which respectively correspond to the plurality of images, and then, a relevance field is generated by fitting the NeRF to the plurality of relevance maps.

At operation 606, the relevance guided scene editing method is performed, based on the input scene, the text instruction, and the generated (estimated) relevance field. In some embodiments, the relevance guided scene editing method may include operations 404, 406, 410, and 408 described above and shown in FIG. 4.

In some embodiments, the relevance guided scene editing method includes: generating an edited image and a updated relevance map corresponding to the edited image by performing a relevance guided image editing method on an original image of the plurality of images and a rendered image obtained from the fitted NeRF, based on the text instruction and a relevance map obtained from the relevance field (operation 800), and updating the NeRF and the relevance field with the generated edited image and updated relevance map (operating 802). Operations 800 and 802 may correspond to operation 416 shown in FIG. 4.

In some embodiments, the relevance guided image editing method may include: generating a first noisy image of the each of the plurality of images by adding first noise to the input image by using the diffusion model (operation 804); inputting the each of the plurality of images and the first noisy image to a first IP2P Unet without any text instruction and inputting the each of the plurality of images and the first noisy image to a second IP2P Unet with a text instruction (operation 806); obtaining a difference between a first output of the first IP2P Unet and a second output of the second IP2P Unet (operation 808); and normalizing the obtained difference (operation 810).

At operation 608, as a result, the edited scene is provided to the user.

In some embodiments, the relevance guided scene editing method includes applying the generated (estimated) relevance field to the IN2N and receiving an edited image about a particular view of the object. In some embodiments, the IN2N may correspond to or may be included in a diffusion model.

FIG. 7 illustrates one diffusion process of the relevance guided image editing method. That is, the relevance guided image editing method of the disclosure may include multiple diffusion processes and FIG. 7 illustrates one diffusion process of the multiple diffusion processes. The operations, shown in FIG. 7 and described below, may be repeated.

In some embodiments, the relevance guided image editing method includes generating a second noisy image of the input image by adding second noise to the input image by using the diffusion model (operation 700); generating a third noisy image of the input image, which comes from an output of a previous step of a relevance guided IP2P denoising step (operation 702); receiving, from an IP2P code of the improved IP2P, an output image of the third noisy image, which is obtained via a denoising step of the diffusion model (operation 704); and generating the rendered image by the IP2P code based on the relevance map, the second noisy image of the input image, the output image from the IP2P (operation 706).

At operation 702, the third noisy comes from the output of previous step of relevance guided IP2P denoising step. So, the input to step T−1 is the output from step T (the third noisy image) as well as the unedited noisy image corresponding to step T−1 (the second noisy image).

In some embodiments, operation 706 may include generating a first set of pixels by multiplying pixels of the second noisy image of the input image with unmasked pixels, wherein the unmasked pixels correspond to pixels of (1−the relevance map) (operation 708); generating a second set of pixels by multiplying pixels of the third noisy image of the input image with masked pixels (wherein the masked pixels correspond to pixels of the relevance map (operation 710); and generating the rendered image by adding the first set of pixels to the second set of pixels (operation 712). Operations 708 to 712 may correspond to operation 316 shown in FIG. 3 and described above.

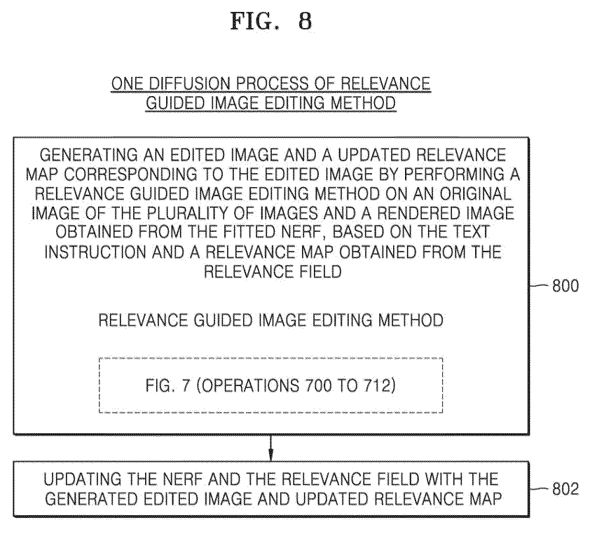

FIG. 8 illustrates one diffusion process of the relevance guided scene editing method in accordance with one or more embodiments of the disclosure. At operation 800, the relevance guided scene editing method includes generating an edited image and a updated relevance map corresponding to the edited image by performing a relevance guided image editing method on an original image of the plurality of images and a rendered image obtained from the fitted NeRF, based on the text instruction and a relevance map obtained from the relevance field. The relevance guided image editing method may correspond to operations 700 to 712 of FIG. 7.

At operation 802, the relevance guided scene editing method includes updating the NeRF and the relevance field with the generated edited image and the updated relevance map.

It is understood that the specific order or hierarchy of steps, operations, or processes disclosed above is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The forecasting method may be written as computer-executable programs or instructions that may be stored in a medium. The medium may continuously store the computer-executable programs or instructions, or temporarily store the computer-executable programs or instructions for execution or downloading.

Also, the medium may be any one of various recording media or storage media in which a single piece or plurality of pieces of hardware are combined, and the medium is not limited to a medium directly connected to electronic device 100, but may be distributed on a network. Examples of the medium include magnetic media, such as a hard disk, a floppy disk, and a magnetic tape, optical recording media, such as CD-ROM and DVD, magneto-optical media such as an optical disk, and ROM, RAM, and a flash memory, which are configured to store program instructions. Other examples of the medium include recording media and storage media managed by application stores distributing applications or by websites, servers, and the like supplying or distributing other various types of software.

The forecasting method may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of the server.

The foregoing disclosure provides illustration and description, but is not intended to be exhaustive or to limit the implementation to the precise form disclosed. Modifications and variations are possible in light of the above disclosure or may be acquired from practice of the implementation.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

The embodiments of the disclosure described above may be written as computer executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to electronic device (e.g., the electronic device 101 of the FIG. 1), but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The above described method may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of the electronic device.

A model related to the neural networks described above may be implemented via a software module. When the model is implemented via a software module (for example, a program module including instructions), the model may be stored in a computer-readable recording medium.

Also, the model may be a part of the electronic device described above by being integrated in a form of a hardware chip. For example, the model may be manufactured in a form of a dedicated hardware chip for artificial intelligence, or may be manufactured as a part of an existing general-purpose processor (for example, a CPU or application processor) or a graphic-dedicated processor (for example a GPU). Also, the model may be provided in a form of downloadable software. A

computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server of the manufacturer or electronic market, or a storage medium of a relay server.

While the embodiments of the disclosure have been described with reference to the figures, it will be understood by those of ordinary skill in the art that various changes in form and details may be made therein without departing from the spirit and scope as defined by the following claims.

1. A method for editing a local area of a target image using a diffusion model, the method comprising:
receiving, from a user of an electronic device, an input image;
receiving, from the user, a text instruction to edit the input image;
generating a relevance map based on the diffusion model and the text instruction;
generating a rendered image by performing a relevance guided image editing method on the input image, based on the generated relevance map; and
providing, to the user, the generated rendered image,
wherein the relevance guided image editing method comprises:
generating a second noisy image of the input image by adding second noise to the input image by using the diffusion model;
generating a third noisy image of the input, which comes from an output of a previous step of a denoising step of the diffusion model;
receiving, from a code of the diffusion model, an output image of the third noisy image, which is obtained via the denoising step of the diffusion model; and
generating the rendered image by the code based on the relevance map, the second noisy image of the input image, the output image received from the diffusion model.

2. The method of claim 1, wherein the diffusion model corresponds to an improved InstructPix2Pix (IP2P).

3. The method of claim 1, wherein the receiving the input image comprises at least one of: capturing the input image by the user, loading the image by the user from a storage of the electronic device, or receiving the input image from an outside of the electronic device.

4. The method of claim 1, wherein the text instruction corresponds to an instruction generated by a speech-to-text operation.

5. The method of claim 1, wherein the diffusion model comprises a first Unet and a second Unet, and
wherein the generating the relevance map based on the diffusion model and the text instruction, comprises:
generating a first noisy image of the input image by adding first noise to the input image by using the diffusion model;
inputting the input image and the first noisy image to the first Unet without any text instruction and inputting the input image and the first noisy image to the second Unet with a text instruction;
obtaining a difference between a first output of the first Unet and a second output of the second Unet; and
normalizing the obtained difference.

6. The method of claim 5, wherein the first Unet and the second Unet are the same InstructPix2Pix (IP2P) Unet.

7. The method of claim 1, the generating the rendered image based on the relevance map, the second noisy image of the input image, the output image received from the diffusion model, comprises:
generating a first set of pixels by multiplying pixels of the second noisy image of the input image with unmasked pixels, wherein the unmasked pixels correspond to pixels of (1−the relevance map);
generating a second set of pixels by multiplying pixels of the third noisy image of the input image with masked pixels, wherein the masked pixels correspond to pixels of the relevance map; and
generating the rendered image by adding the first set of pixels to the second set of pixels.

8. A method for editing a local area of a target scene using a diffusion model comprising a Neural Radiance Field (NeRF), the method comprising:
receiving, from a user of an electronic device, an input scene comprising a plurality of images and fitting the NeRF to the plurality of images;
receiving, from the user of the electronic device, a text instruction to edit the input scene;
generating a plurality of relevance maps respectively corresponding to the plurality of images, and generating a relevance field by fitting the NeRF to the plurality of relevance maps;
generate an edited scene by performing a relevance guided scene editing method, based on the input scene, the text instruction, and the generated relevance field; and
providing, to the user of the electronic device, the edited scene,
wherein the relevance guided scene editing method comprises:
generating an edited image and an updated relevance map corresponding to the edited image by performing a relevance guided image editing method on an original image of the plurality of images and a rendered image obtained from the fitted NeRF, based on the text instruction and a relevance map obtained from the relevance field, and
updating the NeRF and the relevance field with the generated edited image and the updated relevance map, and
wherein the relevance guided image editing method comprises:
generating a second noisy image of the original image by adding second noise to the original image by using the diffusion model;
generating a third noisy image of the original image, which comes from an output of a previous step of a denoising step of the diffusion model;
receiving, from a code of the diffusion model, an output image of the third noisy image, which is obtained via the denoising step of the diffusion model for the third noisy image; and
generating the edited image by the code based on the relevance map, the second noisy image of the original image, the output image from the code.

9. The method of claim 8, wherein the diffusion model comprises an improved InstructNeRF2NeRF (IN2N) and an improved InstructPix2Pix (IP2P).

10. The method of claim 8, wherein the text instruction corresponds to an instruction generated by a speech-to-text operation.

11. The method of claim 8, wherein the diffusion model comprises a first Unet and a second Unet,
wherein the generating the plurality of relevance maps respectively corresponding to the plurality of images, comprises:
generating a first noisy image of each of the plurality of images by adding first noise to the edited image by using the diffusion model;
inputting the each of the plurality of images and the first noisy image to the first Unet without any text instruction and inputting the each of the plurality of images and the first noisy image to the second Unet with a text instruction;
obtaining a difference between a first output of the first Unet and a second output of the second Unet; and
normalizing the obtained difference.

12. The method of claim 11, wherein the first Unet and the second Unet are the same InstructPixel2Pixel (IP2P) Unet.

13. An electronic device for editing a local area of a target image using a diffusion model, the electronic device comprising:
at least one processor comprising processing circuitry; and
memory coupled to the at least one processor, the memory configured to store one or more instructions which, when executed by the at least one processor individually or collectively, cause the electronic device to:
receive, from a user of the electronic device, an input image;
receive, from the user, a text instruction to edit the input image;
generate a relevance map based on the diffusion model and the text instruction;
generate a rendered image by performing a relevance guided image editing method on the input image, based on the generated relevance map; and
provide, to the user, the generated rendered image,
wherein the relevance guided image editing method, performed by the electronic device, comprises:
generating a second noisy image of the input image by adding second noise to the input image by using the diffusion model;
generating a third noisy image of the input, which comes from an output of a previous step of a denoising step of the diffusion model;
receiving, from a code of the diffusion model, an output image of the third noisy image, which is obtained via the denoising step of the diffusion model; and
generating the rendered image by the code based on the relevance map, the second noisy image of the input image, the output image received from the diffusion model.

14. The electronic device of claim 13, wherein the diffusion model corresponds to an improved InstructPix2Pix (IP2P).

15. The electronic device of claim 13, wherein the receiving the input image comprises at least one of: capturing the input image by the user, loading the image by the user from a storage of the electronic device, or receiving the input image from an outside of the electronic device.

16. The electronic device of claim 13, wherein the text instruction corresponds to an instruction generated by a speech-to-text operation.

17. The electronic device of claim 13, wherein the diffusion model comprises a first Unet and a second Unet, and
wherein the generating the relevance map based on the diffusion model and the text instruction, comprises:
generating a first noisy image of the input image by adding first noise to the input image by using the diffusion model;
inputting the input image and the first noisy image to the first Unet without any text instruction and inputting the input image and the first noisy image to the second Unet with a text instruction;
obtaining a difference between a first output of the first Unet and a second output of the second Unet; and
normalizing the obtained difference.

18. The electronic device of claim 17, wherein the first Unet and the second Unet are the same InstructPix2Pix (IP2P) Unet.

19. The electronic device of claim 13, the generating the rendered image based on the relevance map, the second noisy image of the input image, the output image received from the diffusion model, comprises:
generating a first set of pixels by multiplying pixels of the second noisy image of the input image with unmasked pixels, wherein the unmasked pixels correspond to pixels of (1−the relevance map);
generating a second set of pixels by multiplying pixels of the third noisy image of the input image with masked pixels, wherein the masked pixels correspond to pixels of the relevance map; and
generating the rendered image by adding the first set of pixels to the second set of pixels.
